(19) United States
(12) Patent Application Publication
(10) Pub. No.: US 2007/0226304 A1
(43) Pub. Date: Sep. 27, 2007

(54) System and method for migrating user account data

(75) Inventors: Sarinder Virk, Maple Valley, WA (US); Ian Pedersen, Kirkland, WA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: TEAMON SYSTEMS, INC., Issaquah, WA (US)

(21) Appl. No.: 11/389,917

(22) Filed: Mar. 27, 2006

(51) Int. Cl. G06F 15/16

(52) U.S. Cl. 709/206; 709/203

(57) ABSTRACT

A system migrates user account data from an integrated electronic mailbox to a new electronic mail service. An electronic mail (email) server is operative as a web client and has an integrated electronic mailbox of a user and user account data. A mobile office platform is operative with the email server and has at least one stored procedure for pulling user account data from the email server into a new electronic mail service at the mobile office platform.

### FIELD OF THE INVENTION

The present invention relates to the field of communications systems, and, more particularly, to electronic mail (email) communications systems and related methods.

### BACKGROUND OF THE INVENTION

Electronic mail (email) has become an integral part of business and personal communications. As such, many users have multiple email accounts for work and home use. Moreover, with the increased availability of mobile cellular and wireless local area network (LAN) devices that can send and receive emails, many users wirelessly access emails from mailboxes stored on different email storage servers (e.g., corporate email storage server, Yahoo, Hotmail, AOL, etc.).

Yet, email distribution and synchronization across multiple mailboxes and over wireless networks can be quite challenging, particularly when this is done on a large scale for numerous users. For example, different email accounts may be configured differently and with non-uniform access criteria. Moreover, as emails are received at the wireless communications device, copies of the emails may still be present in the original mailboxes, which can make it difficult for users to keep their email organized.

One particularly advantageous “push” type email distribution and synchronization system is disclosed in U.S. Pat. No. 6,779,019 to Mousseau et al., which is assigned to the present Assignee and is hereby incorporated herein by reference. This system pushes user-selected data items from a host system to a user's mobile wireless communications device upon detecting the occurrence of one or more user-defined event triggers. The user may then move (or file) the data items to a particular folder within a folder hierarchy stored in the mobile wireless communications device, or may execute some other system operation on a data item. Software operating at the device and the host system then synchronizes the folder hierarchy of the device with a folder hierarchy of the host system, and any actions executed on the data items at the device are then automatically replicated on the same data items stored at the host system, thus eliminating the need for the user to manually replicate actions at the host system that have been executed at the mobile wireless communications device.

The foregoing system advantageously provides great convenience to users of wireless email communication devices for organizing and managing their email messages. Yet, further convenience and efficiency features may be desired in email distribution and synchronization systems as email usage continues to grow in popularity. An email push system often requires some mass migration from a web client system having an email service to a more sophisticated internet service, but it is not always desirable to allow a mass migration of data from one system to the new electronic mail system operative as an upgraded system because data often is not synchronized in a mass migration. Inconsistencies could remain between the new data and old data, in which a huge amount of data may be provided from different providers, creating inconsistencies. For example, the older email service as a web client could indicate that a Personal Identification Number (PIN) belongs to a portable wireless communications device in which the new email service does not have a record, even after migration.

### BRIEF DESCRIPTION OF THE DRAWINGS

Other objects, features and advantages of different embodiments will become apparent from the detailed description which follows, when considered in light of the accompanying drawings in which:

Other objects, features and advantages of different embodiments will become apparent from the detailed description which follows, when considered in light of the accompanying drawings in which:

FIG. 1 is schematic block diagram of a direct access electronic mail (email) distribution and synchronization system.

FIG. 2 is a schematic block diagram of an exemplary embodiment of user interface components of the direct access proxy of the system of FIG. 1.

FIG. 3 is a schematic block diagram of an exemplary embodiment of the Web client engine of the system of FIG. 1.

FIG. 4 is a schematic block diagram of an exemplary embodiment of the mobile office platform engine machine for use in the system of FIG. 1.

FIG. 5 is a schematic block diagram of an exemplary embodiment of the database module of the system of FIG. 1.

FIG. 6 is a schematic block diagram of another embodiment of user interface components of the direct access proxy similar to that shown in FIG. 2.

FIG. 7 is a sequence diagram for the migration in accordance with one non-limiting embodiment.

FIG. 8 is a schematic block diagram illustrating an exemplary mobile wireless communications device that can be used with the Direct Access system shown in FIG. 1.

### DETAILED DESCRIPTION OF THE PREFERRED EMBODIMENTS

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art. Like numbers refer to like elements throughout.

A system migrates user account data from an integrated electronic mailbox to a new electronic mail service. An electronic mail (email) server is operative as a web client and has an integrated electronic mailbox of a user and user account data. A mobile office platform is operative with the email server and has at least one stored procedure call for pulling user account data from the email server into a new electronic mail service at the mobile office platform.

The mobile office platform can be operative for querying a user of the integrated electronic mailbox whether the user desires to migrate the user account data into the new electronic mail service. The mobile office platform is also operative for querying a user to accept new terms and conditions of the new electronic mail service in order to log-in to a user interface using HTTP or WAP. This email server could include a simple object access protocol (SOAP) interface to pull the user account data from the integrated electronic mailbox. The mobile office platform also includes a SOAP interface operative for creating a new, integrated electronic mailbox account of the new electronic mail service.

In yet another aspect, the system can include a mobile wireless communications device having a subscriber account associated therewith. The electronic mail (email) server is operative as a web client and has an integrated electronic mailbox for the subscriber account of the user and contains user account data. The mobile office platform is operative with the email server and has at least one stored procedure call for pulling the user account data from the email server into a new electronic mail service at the mobile office platform and is operative with the mobile wireless communications device as a new subscriber account.

A method is also set forth.

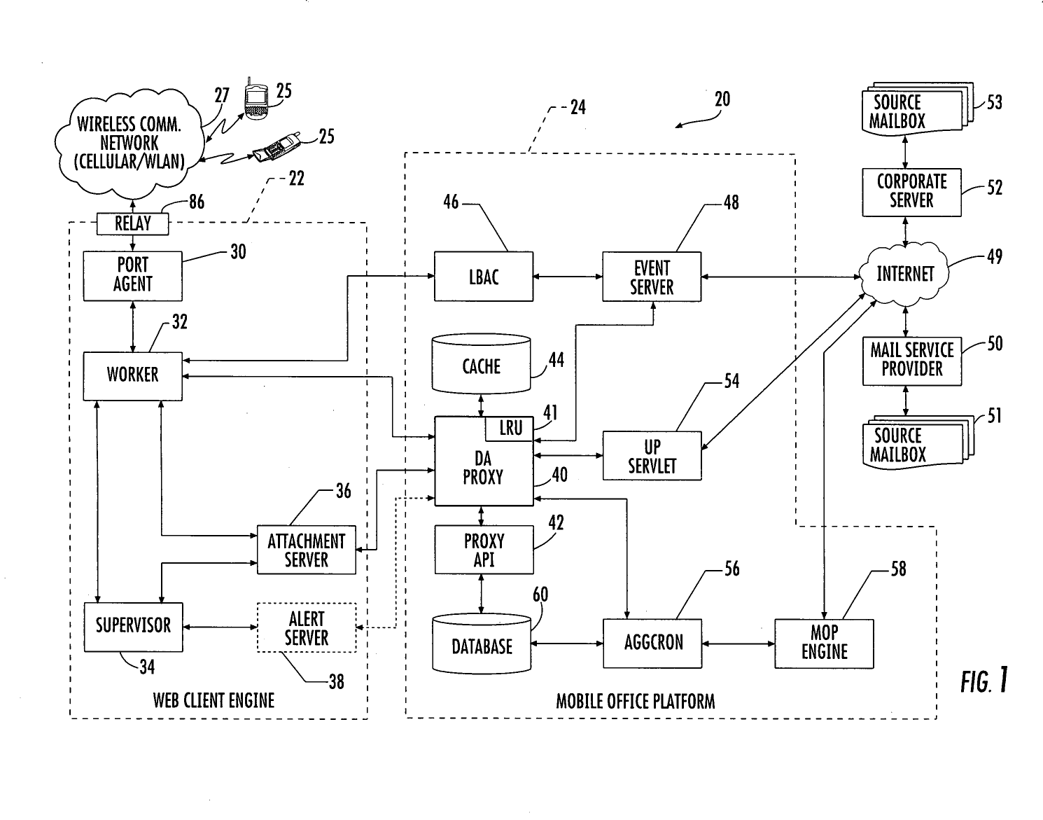

Referring initially to FIG. 1, a direct access (DA) email distribution and synchronization system 20 allows direct access to different mail sources, allowing messages to be transferred directly to a mobile wireless handheld device from a source mailbox. As a result, different mail stores need not be used for integrated external source mail accounts, and a permanent copy of an email in a local email store is not required.

Although this diagram depicts objects as functionally separate, such depiction is merely for illustrative purposes. It will be apparent to those skilled in the art that the objects portrayed in this figure can be arbitrarily combined or divided into separate software, firmware or hardware components. Furthermore, it will also be apparent to those skilled in the art that such objects, regardless of how they are combined or divided, can execute on the same computing device or can be arbitrarily distributed among different computing devices connected by one or more networks.

The direct access system 20 enables email users or subscribers to have email from third party email services pushed to various mobile wireless communications devices 25. Users need not create a handheld email account to gain direct access to an existing external email account. The direct access system 20 may operate without performing aggregation as used in some prior art systems, in which emails are aggregated from multiple different source mailboxes to a single target mailbox. In other words, email need not be stored in an intermediate target mailbox, but instead may advantageously be accessed directly from a source mail store.

As illustrated in FIG. 1, the direct access system 20 illustratively includes a Web client (WC) engine 22 and a mobile office platform (MOP) 24. These Web client engine 22 and mobile office platform 24 operate together to provide users with direct access to their email from mobile wireless communications devices 25 via one or more wireless communications networks 27, for example. Both the Web client engine 22 and the mobile office platform 24 may be located at the same location or at separate locations, and implemented in one or more servers. The web client engine 22 illustratively includes a port agent 30 for communicating with the wireless communications devices 25 via the wireless communications network(s) 27, a worker 32, a supervisor 34, and an attachment server 36, which will be discussed further below. An alert server 38 is shown in dashed lines, and in one preferred embodiment, is not used, but could be part of the system in yet other embodiments.

The mobile office platform 24 illustratively includes a DA proxy 40, and a proxy application programming interface (API) 42 and a cache 44 cooperating with the DA proxy. The mobile office platform 24 also illustratively includes a load balance and cache (LBAC) module 46, an event server 48, a universal proxy (UP) Servlet 54, an AggCron module 56, a mobile office platform (MOP) engine 58, and a database (DB) engine 60, which will be discussed in further detail below. The Least Recently Used (LRU) cache 41 caches new messages, and can release messages and objects that were least recently used.

The supervisor 34 processes new mail notifications that it receives from the direct access proxy 40. It then assigns a job, in the form of a User Datagram Protocol (UDP) packet, to the least-loaded worker 32, according to the most recent UDP heartbeat the supervisor 34 has received. For purposes of this description, heartbeat is a tool that monitors the state of the server. Additionally, the supervisor 34 will receive a new service book request from the direct access proxy 40 to send service books to the mobile wireless communication device for new or changed accounts. A service book can be a class that could contain all service records currently defined. This class can be used to maintain a collection of information about the device, such as connection information or services, such as an email address of the account.

The worker 32 is an intermediary processing agent between the supervisor 34 and the port agent 30, and responsible for most processing in the Web client engine 22. It will retrieve e-mail from a universal proxy 54, via a direct access proxy, and format e-mail in Compressed Multipurpose Internet Mail Extension (CMIME) as a type of Multipurpose Internet Mail Extension, and send it to the port agent 30, for further processing. Its responsibilities include the following tasks: (1) messages sent to and received from the handheld; (2) message reply, forward and more requests; (3) Over The Air Folder Management operation (OTAFM); (4) attachment viewing; and (5) service book.

The port agent 30 acts as a transport layer between the infrastructure and the rest of the Web client engine 22. It is responsible for delivering packets to and from the mobile wireless communications device. To support different integrated mailboxes with one device, more than one service book can be used, and each service book can be associated with one integrated mailbox. A port agent 30 can include one Server Relay Protocol (SRP) connection to a relay, but it can also handle multiple SRP connections, and each connection may have a unique Globally Unique Identifier (GUID) associated with a service book. The attachment server 36 provides service for document/attachment conversion requests from workers 32.

The direct access proxy 40 provides a Web-based Distributed Authoring and Versioning (WebDAV) interface that is used by the worker 32 to access account and mailbox information. This provides functionality to create, change and move documents on a remote server, e.g., a Web server. The direct access proxy 40 typically will present an asynchronous interface to its clients. The LBAC module 46 is used by a notification server and the Web client engine 22 components to locate the proper DA proxy for the handling of a request. The universal proxy Servlet 54 abstracts access to disparate mail stores into a common protocol. The event server 48 responds to notifications of new messages from corporate servers 52 and/or mail service providers 50, which may be received via the Internet 40, for example. The notifications are communicated to the direct access proxy 40 by the AggCron module 56 and the event server 48 so that it may initiate checking for new mail on source mailboxes 51, 53 of the mail service providers 50 and/or corporate servers 52. The proxy API can be a Simple Object Access Protocol (SOAP) Daemon 42 and is the primary interface into a database 60, which is the primary data store for the mobile office platform 24. The AggCron module 56 may also periodically initiate polling for new messages as well.

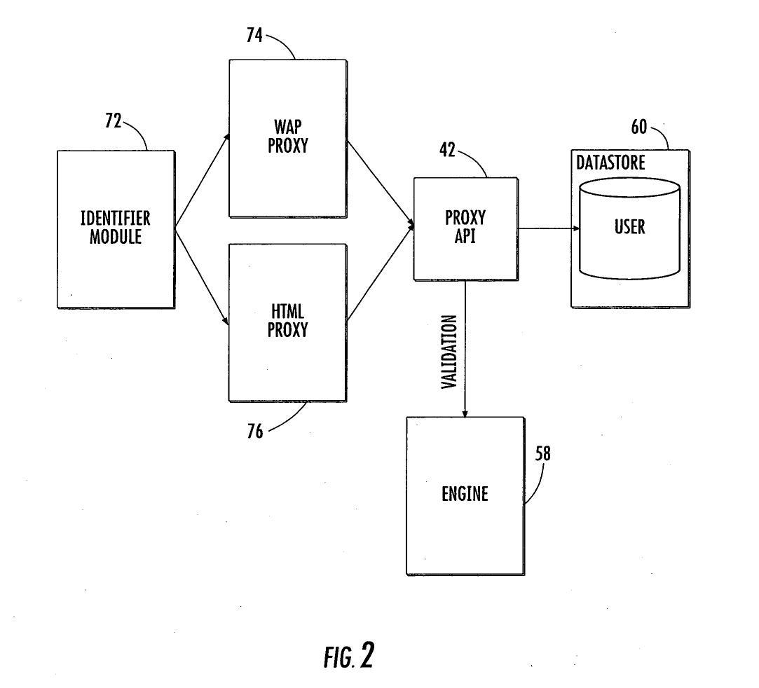

FIG. 2 is a high-level block diagram showing user interface components of the direct access proxy 40. More particularly, the direct access proxy 40 illustratively includes an identifier module 72 with various downstream proxy modules for different communication formats, such as a Wireless Application Protocol (WAP) proxy module 74 and a Hypertext Markup Language (HTML) proxy module 76. Of course, it will be appreciated by those skilled in the art that other types of proxy modules for other communications formats may also be used.

The identifier module 72 provides a centralized authentication service for the direct access system 20 and other services. An authentication handshake may be provided between an ID service and direct access system 20 to ensure that users have the proper credentials before they are allowed access to the direct access system 20. The ability to switch from managing a Web client to a direct access system, or vice versa, may occur without requiring the user to re-enter any login credentials. Any Web client and direct access may share session management information on behalf of a user.

The WAP proxy 74 provides a wireless markup language (WML)-based user interface for configuring source mailboxes with the mobile office platform 24. The HTML proxy 76 provides an HTML-based user interface for configuring of source mailboxes in the MOP 24. The proxy API 42 (SOAP Daemon) is the primary interface into the database 60. The engine 58 is a protocol translator that connects to a source mailbox to validate configuration parameters. The database 60 is the primary user data store for the mobile office platform 24.

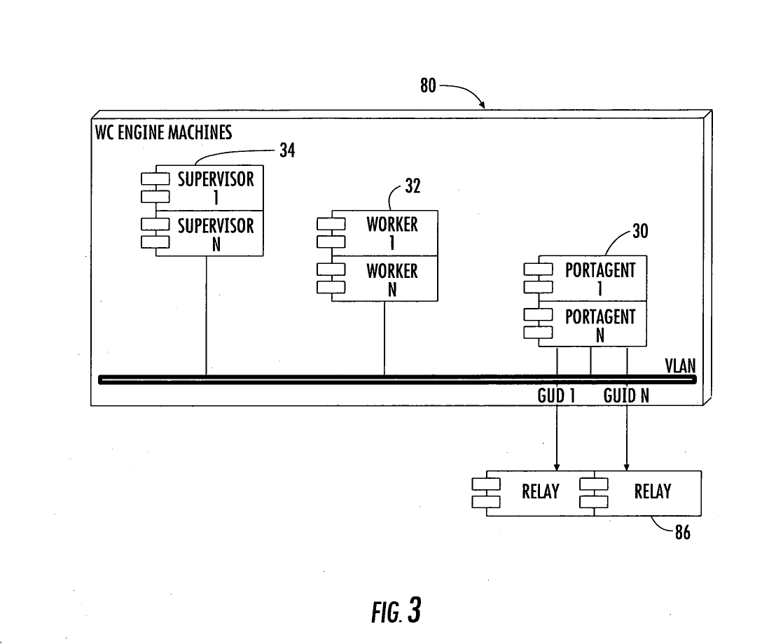

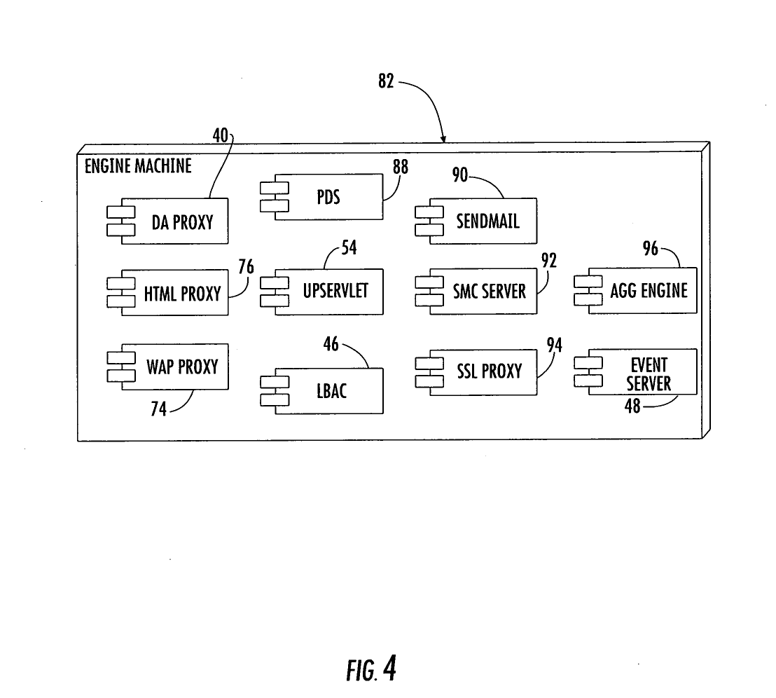

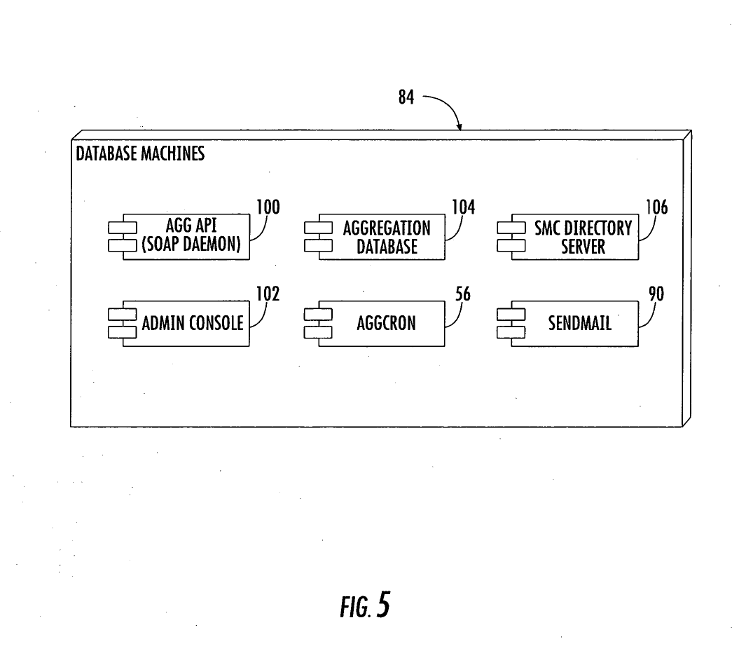

FIGS. 3, 4 and 5 illustrate respective Web client engine machines 80 (FIG. 3), an engine machine 82 (FIG. 4), and database machine 84 (FIG. 5). The Web client engine machine 80 illustratively includes the supervisors 34, workers 36, and port agents 38. Relays 86 cooperate with the port agents 38 using a GUID.

The engine machine 82 illustratively includes a direct access proxy 40, HTML proxy 76, WAP proxy 74, PDS module 88, UP Servlet 54, LBAC module 46, a sendmail module 90, an secure mail client (SMC) server 92, a secure sockets layer (SSL) proxy 94, an aggregation engine 96, and event server 48. The SMC server 92 cooperates with corresponding SMC modules resident on certain corporate networks, for example, to convey email data between the mobile office platform 24 and source mailboxes. The database machine 84 may include an aggregation application programming interface (API) 100 as a SOAP Daemon, an administration console 102, an aggregation database 104, the AggCron module 56, an SMC directory server 106, and a send mail module 90.

The various components of the Web client engine 22 may be configured to run on different machines or servers. The component binaries and configuration files may either be placed in a directory on the network or placed on a local disk that can be accessed to allow the appropriate components to run from each machine. In accordance with one exemplary implementation, deployment may include one supervisor, two workers, and one port agent for supporting 30,000 external source mailboxes, although other configurations may also be used. Actual production deployment may depend on the results of load, performance and stress testing, as will be appreciated by those skilled in the art.

For the mobile office platform 24 direct access components, modules and various functions, machines are typically installed in two configurations, namely engine machines (FIG. 4) and database machines (FIG. 5). While these machines may have all of the above-described components installed on them, not all of these components need be active in all applications (e.g., aggregation may be used with systems that do not support push technology, etc.). Once again, actual production deployment may depend on the results of load, performance and stress testing.

The mobile office platform 24 architecture in one known technique advantageously uses a set of device/language-specific eXtensible Stylesheet Language (XSL) files, which transform application data into presentation information. In one non-limiting example, a build process takes a non-localized XSL and generates a localized XSL for each supported language. When the XSL is used, it is “compiled” in memory and cached for repeated use. The purpose of pre-localizing and caching the templates is to reduce the CPU cycles required to generate a presentation page.

Branding may also be performed. Initially, a localized XSL may build a WAP application to access aggregated email accounts. A WAP proxy application may be localizable and support multiple WAP devices. For each logical page of an application, a device-specific XSL may be created, which may be localized for each language/country supported. This rendering scheme may support not only WAP devices, but also SMTP, HTML and POP proxies, for example. In branding, each page of a given application may be customized for each different brand.

The branding of a page may be accomplished through XSL imports, including the use of a Java application programming interface (API) for XML processing (JAXP) feature to resolve the imports dynamically. This need not require that each combined page/brand template be compiled and cached. By way of example, in a sample template directory, first and second pages for a single language/country may be combined with branded counterparts to generate a plurality of distinct template combinations. It is also possible to profile memory requirements of an application by loading templates for a single language, device/application and brand. An HTML device may include a set of templates that are large compared to other devices.

In one known technique, the mobile office platform 24 advantageously builds processes and takes non-localized files and language-specific property files and combines them to make each non-localized XSL into an XSL for each supported language. A separate XSL for each language need not be used, and the language factor may be removed from the memory usage equation. A JAXP API may be used to extend XSL with Java classes. The extensions may take various forms, for example, including extension elements and extension functions. A template may be transformed by creating and initializing an extension object with a locale and passing an object to a transformer. The system can remove multiple imports and use less memory. HTML templates can use template importing to enable template reuse, much like Java classes, and reuse other Java classes through a mechanism like derivation or importing.

In the direct access system 20, users receive email on their mobile wireless communications devices 25 from multiple external accounts, and when replying to a received message, the reply-to and sent-from address integrity is preserved. For example, for a user that has an integrated Yahoo! account (user@yahoo.com) and a POP3 account (user@pop3.com), if they receive an email at user@yahoo.com, their replies generated from the device 25 will appear to come from user@yahoo.com. Similarly, if a user receives an email at user@pop3.com, their replies will appear to come from user@pop3.com.

Selection of the “sent from” address is also available to a user that composes new messages. The user will have the ability to select the “sent from” address when composing a new message. Depending on the source mailbox type and protocol, the message may also be sent through the source mail service. This functionality can be supported by sending a configuration for each source mailbox, for example, as a non-limiting example, a service book for each source mailbox 51, 53 to the mobile wireless communications device 25.

As noted above, a service book is a class that may include all service records currently defined. This class may be used to maintain a collection of information about the device, such as connection information. The service book may be used to manage HTTP connections and mail (CMIME) information such as account and hierachy. At mobile wireless communications devices 25, a delete service book request may be sent when a source mailbox 51, 53 is removed from the account. The service book may also be resent to the device 25 with a viewable name that gives the user some indication that the selection is no longer valid.

A sent items folder may also be “synchronized.” Any device-originated sent messages may be propagated to a source account and stored in a sent mail folder, for example. Also, messages deleted on the device 25 may correspondingly be deleted from the source mailbox 51, 53. Another example is that device-originated marking of a message as read or unread on the device 25 may similarly be propagated to the source mailbox 51, 53. While the foregoing features are described as source-dependent and synchronizing one-way, in some embodiments certain synchronization features may in addition, or instead, propagate from the source mailbox/account to the handheld device, as will be appreciated by those skilled in the art.

When available, the mail service provider or corporate mail server may be used for submission of outgoing messages. While this may not be possible for all mail service providers or servers, it is preferrably used when available as it may provide several advantages. For example, subscribers to AOL will get the benefit of AOL-specific features like parental controls. Furthermore, AOL and Yahoo users, as non-limiting examples, will see messages in their sent items folder, and messages routed in this manner may be more compliant with new spam policies such as Sender Policy Framework (SPF) and Sender Id. In addition, messages sent via corporate mail servers 52 will have proper name resolution both at the global address list level and the personal level. It should be understood, however, that the use of the mail service provider 50 to deliver mail may be dependant on partner agreements and/or protocol, depending upon the given implementation.

The architecture described above also advantageously allows for features such as on-demand retrieval of message bodies and attachments and multiple folder support. Morever, a “this-is-spam” button or indicator may be used allowing company labels and other service provider-specific features when supported by an underlying protocol, as will be appreciated by those skilled in the art.

One particular advantage of the direct access system 20 is that a user need not configure an account before integrating additional accounts. However, a standalone email address may be used, and this address advantageously need not be tied to a mailbox size which the subscriber is required to manage. For example, the email account may be managed by an administrator, and any mail could be purged from the system after a pre-determined period of time (i.e., time-based auto-aging with no mailbox limit for all users).

Additionally, all aspects of any integrated email account creation, settings and options may advantageously be available to the user from their mobile wireless communications device 25. Thus, users need not visit an HTML site and change a setting, create a filter, or perform similar functions, for example. Of course, an HTML site may optionally be used.

As a system Internet email service with the direct access system 20 grows, ongoing emphasis may advantageously be placed on the administrative site to provide additional information to carrier administrators, support teams, and similar functions. However, in some instances a mail connector may be installed on a personal computer, and this functionality may not always be available from the mobile wireless communications device.

The Web client engine 22 may advantageously support different features including message to handheld (MTH), message from handheld (MFH), forward/reply a message, request to view more for a large message (e.g., larger than 2K), request viewing message attachment, and over the air folder management (OTAFM). These functions are explained below.

For an MTH function, each email account integrated for a user is linked with the user device through a Web client service book. For each new message that arrives in the Web client user mailbox, a notification that contains the new message information will typically be sent to a Web client engine supervisor component (FIG. 3), which in turn will assign the job to an available worker with the least load in the system. The chosen worker 32 will validate the user information and retrieve the new message from the user source mailbox and deliver it to the user device.

In an MFH function, MFH messages associated with a Web client service book are processed by the Web client engine 22 and delivered to the Internet 49 by the worker 32 via the simple mail transfer protocol (SMTP) or native outbox. If a user turns on the option to save the sent message to the sent items folder, the direct access proxy will save a copy of the sent message to this folder.

In a Forward/Reply/More function, the user can forward or reply an MTH or MFH message from the mobile wireless communications device 25 as long as the original message still existed in the direct access proxy cache or in user mailbox. For MTH, the worker 32 may send the first 2K, for example, or the whole message (whatever is less) to the user device. If the message is larger than 2K, the user can request MORE to view the next 2K of the message. In this case, the worker 32 will process the More request by retrieving the original message from the user source mailbox, and send back the 2K that the device requests. Of course, in some embodiments more than 2K of message text (or the entire message) may be sent.

In an attachment-viewing function, a user can view a message attachment of a popular document format (e.g., MS Word, MS Power Point, MS Excel, Word Perfect, PDF, text, etc.) or image format (GIF, JPEG, etc). Upon receiving the attachment-viewing request, which is implemented in a form of the more request in this example, the worker 32 can fetch the original message from the user source mailbox via the direct access proxy, extract the requested attachment, process it and send result back to the user device. The processing requires that the original message has not been deleted from the user Web client mailbox.

In the save sent message to sent items folder function, if the user turns this option on, the worker 32 places a copy of each MFH message sent from the user device in the user sent items folder in the mailbox. In over the air folder management, the Web client OTAFM service maintains any messages and folders in the user mailbox synchronized with the user device over the air.

Whenever a message in the user source mailbox is Moved/Deleted, the associated message on the device may also be Moved/Deleted accordingly, and vice-versa. When a message is Moved/Deleted on the device, the associated message in the user Web client mailbox may also be Moved/Deleted accordingly. Similarly, when a folder is Added/Removed/Renamed from the user Web client mailbox, the associated folder on the device may be Added/Removed/Renamed, and vice-versa.

The system 20 may advantageously support different subsets of various messaging features. For example, in the message to handheld function, the mobile office platform 24 may be responsible for connecting to the various source mailboxes 51, 53 to detect new emails. For each new mail, a notification is sent to the Web client engine 22 and, based on this notification, the supervisor 34 chooses one of the workers 32 to process that email. The chosen worker will fetch additional account information and the contents of the mail message from the direct access proxy 40 and deliver it to the user device 25.

In a message sent from handheld function, the MFH could be given to the direct access proxy 40 from the Web client worker 32. In turn, the mobile office platform 24 delivers a message to the Internet 49 by sending through a native outbox or sending it via SMTP. It should be understood, however, that the native outbox, whenever possible, may provide a better user experience, especially when taking into account current anti-spam initiatives such as SPF and sender Id.

In a message deleted from handheld function, when a message is deleted from the device 25, the Web client engine 22 notifies the mobile office platform 24 via the direct access proxy 40. As such, the mobile office platform 24 can delete the same message on the source mailbox.

When handling More/Forward/Reply/Attachment viewing requests, the Web client worker 32 may request an original mail from the direct access proxy 40. It will then process the request and send the results to the mobile wireless communications device 25. The architecture may additionally support on-demand retrieval of message parts and other upgrades, for example.

Upon the integration of a new source mailbox 51, 53, the service book notification from the alert server 38 may be sent to the supervisor 34, which assigns this notification to a worker 32 for sending out a service record to the device. Each source mailbox 51, 53 may be associated with a unique service record. In this way, each MFH message is linked with a source mailbox 51, 53 based on the service record on the device.

The system 20 may also poll the integrated external mailboxes periodically to check for new mail and to access any messages. The system 20 may further incorporate optimizations for polling bandwidth from an aggregation component allowing a quick poll. The system 20 can also advantageously support a large active user base and incorporate a rapidly growing user base.

The topology of load balancing can be based on the size of a component's queue and its throughput. These load statistics can be monitored by a mechanism in one example called the UDP Heartbeat, as described before. If a component is overloaded or has a large queue size, the component will have less chance to get an assigned job from other components. In contrast, a component will get more assigned jobs if it completes more jobs in the last few hours than other components. With this mechanism, the load could distribute over heterogeneous machine hardware, i.e., components running on less power machines will be assigned fewer jobs than those on machines with more power hardware.

General load balancing for any mobile office platform components can be accomplished through the use of a load balancer module, for example, a BIG-IP module produced by F5 Networks of Seattle, Wash. BIG-IP can provide load balancing and intelligent layer 7 switching, and can handle traffic routing from the Internet to any customer interfacing components such as the WAP and HTML proxies. The use of a BIG-IP or similar module may provide the application with pooling capabilities, fault tolerance and session management, as will be appreciated by those skilled in the art.

Typically, access to a single source mailbox 51, 53 can be from a single direct access proxy 40 over a persistent connection. Any requests on behalf of a particular user could persist to the same machine in the same direct access clustered partition. As certain components are system-wide and will be handling work for users across many partitions, these components can be designed to determine which direct access partition to communicate with on a request-by-request basis.

The load balancer and cache (LBAC) 46 may support this function. The LBAC 46 is a system-wide component that can perform two important functions. The first of these function is that it provides a mapping from the device PIN to a particular direct access proxy 40, while caching the information in memory for both fast access and to save load on the central database. Secondly, as the direct access proxy 40 will be run in clustered partitions, the LBAC 46 may distribute the load across all direct access proxies within any partition.

The LBAC 46 can be formed of different components. For example, the code which performs the load balancing can be an extended version of a secure mail connector. The code can also perform lookups to the central database and cache the results (LBAC).

In one non-limiting example, when a worker requires that a direct access proxy 40 perform work, it provides the LBAC 46 with a device PIN. The LBAC 46 will discover which partition that PIN is associated with by looking in its cache, or retrieving the partition identifier from a central database (and caching the result). Once the partition is known, the LBAC 46 then consults its cache to see which direct access proxy in that partition has been designated to handle requests for that PIN. If no mapping exists, the LBAC requests the PDS to create a new association on the least loaded DA proxy 40 (again caching the result). Finally, the LBAC 46 responds to the worker 32 with the connection information for the proper direct access proxy to handle that particular request.

The secure mail connector 88 may run in failover pairs, where one is an active master and the other is a secondary standby. Internal data structures may be replicated in real-time from the master to the standby. Multiple LBACs 46 can be run for scalability and fault tolerance, but typically would require an external connection balancing component, such as the BIG-IP component as explained before.

A receiving component in the Web client engine 22 saves the job that has been assigned to it from other components to a job store on the disk before processing. It can update the status of the job and remove the job from the job store when the job processing is completed. In case of component failure or if the process is restarted, it can recover the jobs from the job store and, based on the current statuses of these jobs, continue processing these jobs to the next state, saving the time to reprocess them from the beginning.

Any recovery from the standpoint of MTH/MFH can be achieved through current polling behavior and on the Web client engine 22 recovery mechanisms. From within the mail office platform components, until a message has been successfully delivered to a Web client engine 22, that message is not recorded in the partition database 60. During the next polling interval, the system can again “discover” the message and attempt to notify the Web client engine 22. For new mail events, if an event is lost, the system can pick up that message upon receiving the next event or during the next polling interval. For sources supporting notifications, this interval could be set at six hours, as one non-limiting example. For messages sent from the Web client engine 22, and for messages that have been accepted by the Web client engine, recovery can be handled by different Web client engine components.

The Web client engine 22 may advantageously be horizontally and vertically scalable. Multiple supervisors 34 can be registered/configured with direct access proxies 40 to provide the distribution of the notification load and the availability of engine service. Multiple workers 32 and port agents 30 can run on the same machine or across multiple machines to distribute load and achieve redundancy. As the number of users grows, new components can be added to the system to achieve high horizontal scalability.

It is possible for a new component to be added/removed to/from the system automatically without down time. Traffic can automatically be delegated to a new component and diverted away from failed components. Each component within the mobile office platform 24 can be deployed multiple times to achieve horizontal scalability. To achieve vertical scalability, each mobile office platform 24 component can be a multi-threaded process with a configurable number of threads to scale under heavy load. Pools of connections can be used to reduce the overhead of maintaining too many open connections.

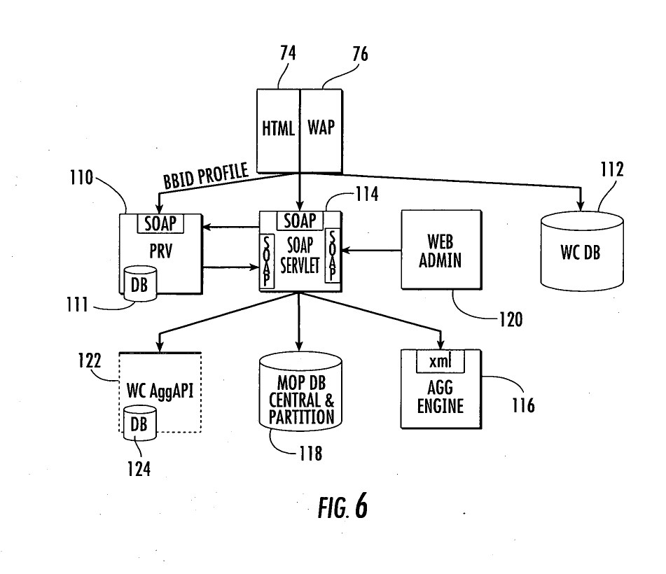

FIG. 6 is another embodiment of the high level architectural diagram of the BDA user interface components similar to the functional components shown in the diagram of FIG. 2. There will now follow a brief description of these basic components and their function.

Provisioning (PRV) 110 provides a centralized database 111 or store to access user and device Identifier (ID) profile information. During login, the WAP and HTML Proxies 74, 76 retrieve the ID profile, which provides user and device information. Proxies update PRV 110 for certain user configuration actions, such as a changed PIN. The web client database 112 (WC DB) contains account information for web client users. It is queried during login to determine if an unknown user is a web client user and whether they can be migrated. The WAP Proxy 74 provides a Wireless Markup Language (WML) based user interface for configuration of source mailboxes in the Mobile Office Platform (MOP). The HTML Proxy 74 provides an HTML based user interface for configuration of source mailboxes in MOP. The Soap Servlet 114 (SOAP Daemon) provides an interface into a database store. The Agg Engine 116 acts as a protocol translator that connects to a source mailbox to validate configuration parameters. The Mobile Office Platform Database (MOP DB) 118 is a primary user data store for the MOP. The Web Admin 120 provides the MOP with notifications of account state changes. Provisioning 110 also provides notification of account state changes, such as inactive and active. Provisioning (PRV) can be used to notify and migrate a user from a Web Client (WC) service to an Internet Service (IS), having more advance features that are accessible from a web browser with a user email account, allowing a user to add and edit email accounts.

The Web Client Aggregation Programming Interface (WC AggAPI) 122 includes a database 124 and provides integrated source data for WC accounts. It is queried to retrieve integrated source configuration data to be migrated to a new Internet Service (IS) account for the user. The WC DB 112 provides web client account information. It is queried to retrieve web client account configuration data to be migrated to a Internet Service account for the user. The system can make use of existing products such as the Provisioning 110 and WebAdmin 120. These products have scaling characteristics. In this described embodiment, functionality has moved from Aggcron to the BDA proxy. The system provides a direct connection to a partition database within the BDA proxy. Access to the database can be from a configurable connection pool that will grow and shrink as necessary, depending on the needs of the system. The pool can recover from network errors and database connectivity issues.

In accordance with a non-limiting embodiment, users in a new electronic mail service at the mobile office platform operative as an Internet Service (IS) have the ability to perform a migration of their existing Web Client/WebMail account data into the MOP Internet Service Email system if their carrier enables it. This feature is coined “self-migration” or “user-initiated migration”.

There are two possible approaches for making the Web Client (WC) data available to the MOP code base.

(1) It is possible to pull user data from a WC database with one (or more) stored procedure (proc) calls at run-time. The procedure call could be any type of subroutine, even a SOAP call. This requires stored procedure (proc) calls from within the MOP codebase and runtime access to the WC database.

(2) It is possible to store all WC user data in Internet Service “import” tables. This requires staging the WC data into the Internet Service import tables at the time of cut-over.

The first option is more typical because not all carriers would opt for simultaneously enabling the internet service at launch. Also, it is unlikely there would be a sufficiently complete dataset available in time. In fact, a complete dataset would be large and unwieldy.

The indicator for whether a site/brand has enabled user-initiated migration could come from a “user_migrated_enabled” column from a “Site” table in the WC/WebMail database.

A carrier will indicate they would like to enable user-initiated migration. A “user_migrated_enabled” bit will be set for that site/brand in the WC. Existing WC users will be prompted at login to migrate to the Internet Service. If they choose not to, then they will be routed to an old WC system and carry on as before. When this user returns later and attempts to login they will again be prompted to migrate to the Internet Service. If the user chooses to migrate then all required account information for this user from the old WC system will be passed to the new IS and a new IS account is created along with a hosted mailbox and any integrated source mailboxes.

After a successful migration, the user would then be routed to the IS system from then on. At this point mail will begin to flow to and from the user's handheld, but in-order to login to the HTML or WAP UI the user will need to accept any new “terms and conditions” that are part of the new Internet Service.

The migration process should happen within seconds, and mail flow should not be interrupted. The only real concern for mail flow interruption during migration is if the user's handheld is off or out of range. This will result in Service Book delivery delay and even failure. Until Service Books are delivered all mail flow is stopped. The old WC account of the user will remain for 30 days to allow access to old pre-migration messages via their handheld, but login access and polling will be disabled. After 30 days the account will be deleted.

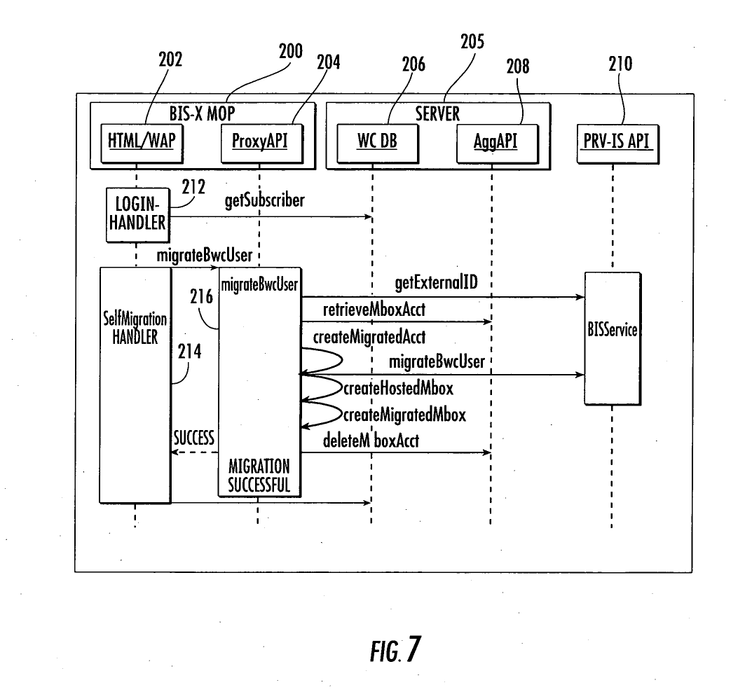

The migration of integrated mailbox data is accomplished by using an AggAPI Soap interface in the WC system to pull the user data as shown in FIG. 7. A ProxyAPI Soap interface in the Internet Service system creates the account, creates the hosted mailbox, and populates the integrated mailbox information. FIG. 7 shows basic components of the Internet Service Mobile Office Platform 200 and its HTML/WAP 202 and Proxy API 204. Also illustrated are the electronic mail server 205 operative as a mail server, and including a web client database 206, AggAPI 208. The PRV-IS API 208 is operative therewith and a flow sequence of operation is shown.

With the HTML/WAP proxy 202, a LoginHandler 212 obtains a WCSubscriber object during user login. The WCSubscriber object contains enough information to create an IS account if the user chooses to migrate. A SelfMigrationHandler 214 makes a migrate wcUser 216 soap call to the ProxyAPI 204. That soap call handles all of the steps involved in user-initiated migration. First, it looks at the IDProfile.loginId parameter. If it is null, then the user has no WC account. Otherwise, it fetches the WC Agg externalId by making a getExternalId soap call to the PRV-IS API and passing the IDProfile.loginId and siteName string concatenated together with a period in between. It uses the externalId to make a retrieveMboxAcct soap call to the WC AggAPI in order to retrieve the mailbox account and any integrated source mailboxes (there may be none). It then makes createMigratedAcct and createHostedMbox calls to itself in order to create the IS account and the hosted mailbox.

As a side-effect, the createMigratedAcct call makes a migrateBwcUser soap call to PRV-IS in order to create a IDProfile for the migrated user. It then makes zero or more createMigratedMbox calls in order to migrate any integrated mailboxes the user may have. It calls deleteMboxAcct in order to delete the WC aggregation account. Upon successfully executing the migrateBwcUsersoap call, the SelfMigrationHandler makes a stored procedure (proc) call to the WC DB in order update the WC subscriber's status to MIGRATED.

Certain database changes are typically required before any user-initiated migration can begin. One change is made in the central database for the MboxProvider/MboxAcctType. In order to easily map between the MOP brand/MboxProviderName and the WC siteName, a MboxProvider table has a column “siteName”. This allows some flexibility in coordinating the data between the Internet Service (IS) MOP and Web Client (WC) systems.

(1) The name of a carrier can be different between the two systems. For example, the carrier T-Mobile Systems is referred to as siteName “tmo” in the WC system and mboxProviderName “tmobile” in MOP.

(2) This allows mappings other than one-to-one for testing purposes. For example, both the “tmobile” and “bisgeneric” mboxProviders can map to the same “cardhutrst” siteName.

A new MboxProvider entry could be made for all existing WC sites to be migrated. New MboxAcctType entries can be made for each site added above. There could be new and unsupported rows for each MboxAcctType entry above, and a MboxAcctTypeMap. This is a new mapping table required to map a site/plan from the old WC system to the new IS system. Locales may need to be changed and there may be a need to add locale data. A partitioned database may be necessary, for example, MboxAcct, in which a new column is “migrated” to hold the date of the user-initiated migration. A hostmailbox database may need to be changed. For example, a CarrierReservedLogin has each carrier providing a list of reserved logins to be added to the CarrierReservedLogin table, which will block all new users for this carrier from integrating these logins. A GlobalReservedLogin could be changed. A list of reserved logins could be added to the GlobalReservedLogin table, which will block all new users from integrating these logins.

A login handler for the Internet Service will obtain the following information from the WC database and pass it into the Internet Service migratewcUser SOAP ProxyAPI call:
Username Used for generating ID and hosted mailbox login.
Password MboxAcct.password.
Site Name Used for generating ID and hosted mailbox domain (full domain will be retrieved from MboxProvider.hostedMailDomain).
Service Plan Used to obtain mboxProviderName/mboxAcctTypeName from MboxAcctTypeMap table.
PIN devicePIN for DevicePINMap.devicePIN and MboxAcct.devicePIN
UTF-8 enabled MboxAcct.settings&65536
Reply To Address Used in logic to determine SrcMbox.address.
Sent From Address Used in logic to determine SrcMbox.address.
Auto BCC Address SrcMbox.autoBCC for POP and IMAP sources only.
Friendly Name SrcMbox.description
Signature SrcMboxSignature table.
Account Status MboxAcct.settings&64 (Active or Suspended)
Created MboxAcct.created (and AcctMap.created?)
Timezone MboxAcct.timezone.
Language MboxAcct.language.
Country MboxAcct.country.
Charset MboxAcct.charset.

The AcctMap.externalID could be the ID. The ID could be the “sitename-username”.

The “Password” could be the user's WC Web login password from “subscriber_engine.user_password”. It is not determined from the MboxAcct.password in WC TeamOn Aggregation database, because that is not used for authentication and therefore is always empty. An example of the logic used to determine the SrcMbox.address (the BIS-X reply to address) is:

If integrated external mailbox then

SrcMbox.address = WC SrcMbox.address from TeamOn
AggAPI

Else is hosted mailbox

If user has integrated external mailboxes then

If the WC sentFrom address matches one of the
external sources

SrcMbox.addess = WC sentFrom address
(integrator)

Else if the WC replyTo address matches one of the
external

sources

SrcMbox.addess = WC replyTo address
(integrator)

Else

If the WC sentFrom address is not null
And is something other than the hosted mailbox
address then

SrcMbox.addess = WC sentFrom address
(forwarder)

Else if the WC replyTo address is not null
And is something other than the hosted mailbox
address then

SrcMbox.addess = WC replyTo address
(forwarder)

End
If no action was taken above then

SrcMbox.addess = hosted mailbox address

End

End

The language, country, and character set values received from WC will be checked against carrier-supported values in the Internet Service. If they are not supported, then carrier defaults will be used. The “UTF-8 enabled” (MboxAcct.settings&65536) is determined from the “subscriber_engine.multi_byte_encoding_enabled” and WC and the O/S version from PRV.

Alert Rules usually will not be migrated. The WC alert rules are stored in a WC database and have a different format. Translating them would not be easy, and would most likely end up with incorrect rules. Filters can be easily re-created by the user. Some data is required from PRV. The MOP ProxyAPI migrateBwcUser SOAP method will request the following information from PRV/BIS-API in separate requests:
ExternalId—This is only required for retrieving user data from the old WC Aggregation databases.
IMEI—Required for devicePIN verification.

Some data is required from AggAPI. The MOP ProxyAPI migrateBwcUser SOAP method will request the following information for each integrated external mailbox from the old WC Aggregation API.
Is Valid SrcMbox.settings&16
Address Used in logic to determine SrcMbox.address
Login SrcMbox.login
Password SrcMbox.password (ensure proper encryption)
Protocol Name SrcMbox.protocolName
SSL Enabled SrcMbox.protocolSettings&8
Server SrcMbox.server
Port SrcMbox.port
Suspended By User SrcMbox.settings&1
PWP Client ID SrcMbox.pwpClientID
Is Desktop SMC SrcMbox.settings&131072
Is Primary User SrcMbox.settings&65536
Date Created SrcMbox.created

Values that the system may want for each source that is currently not returned from the AggAPI are:
Polling Suspended by System SrcMbox.settings&2
Disable Expedited Polling SrcMbox.settings&262144
Force MRU Cache Strategy SrcMbox.settings&2097152

A disable quick polls (SrcMbox.settings&524288) bit typically will not be migrated. Instead all sources in the Internet Service will default to 0 (false) to allow the new Internet Service quick poll logic to determine what source is quick pollable or not. The SubIDMap entries from WC will not be migrated. In WC the SubId value is the WC user id. This was done to allow account search by a users address. Not all users will have an address in the IS. It is optional. Instead, users will be searched by ID, which will be a combination of username and site-name.

There is some account migration. A new method “migrateBwcUser” could perform the actual user migration. This new SOAP method would be called from the new IS migration login handler when a users indicates that they wish to be migrated. It will accept most of the WC data as input and use the following methods to complete the migration process.

A new method “getBrandPlanMapping” can retrieve the new mboxProviderName and mboxAcctTypeName for IS by referring to the new MboxAcctTypeMap table using the old site name and plan from WC. The new method will require the following information as arguments:

String siteName from WC data

String servicePlan from WC data

The output is:

String mboxProviderName

String mboxAcctTypeName

A new method “createMigratedAccount” is required for migrated user account creation in order to incorporate the created date, migrated date, UTF-8 supported flag, and the users current status. This new method may use the following information as arguments:
String externalId←the ID, generated from username and site name
String mboxAcctTypeName←from getBrandPlanMapping
String mboxProviderName←from getBrandPlanMapping
String pword←from WC
String created←from WC
boolean suspended←from WC (false=active, true=suspended)
boolean allowSeamlessLogin=false
Timezone timezone←from WC
String language←from WC
String country←from WC
String targetaddr=null
String charset←from WC
String devicepin←from WC (expects decimal format)
String imei←from PRV
boolean multibyteEnabled←from WC
   The output is:

boolean success (true=success, false=failed)

The existing method “createHostedMailbox” can be used to create the user's hosted mailbox. This method could use following information as arguments:
String externalId←the ID, generated from username and site name
String login←hosted mailbox address (for example, username@sitename.blackberry.net)
String srcAddr←sentFrom/replyTo/source address from WC
int interval←from MboxAcctType.interval for given site name
int sizeLimit←from MboxAcctType.sizeLimit for given site name
int timeout=30
String desc←Friendly Name from WC (or null)
boolean alertsEnabled=true
boolean is PollTypeAlert=false
String trackingInfo←??
String clientType←??
boolean ignoreold=true
   The output is:

long srcMboxID for newly created SrcMbox row

The following values would also be updated for the hosted mailbox:

String autoBccAddr←from WC (or null)

String signature←from WC (or null)

A new method “createMigratedMailbox” would allow for migrated user's source mailbox creation in order to incorporate specific settings bits, autoCC, signature, and to not perform source validation. The source mailbox data is coming from a trusted source, therefore the source valid bit, along with all required source configuration values, will be preserved as it was in the old WC database. This new method typically requires the following information as arguments:
String externalId←the ID, generated from username and site name
String login←from AggAPI Login
String pword←from AggAPI Password
String srcAddr←from AggAPI Address
String server←from AggAPI Server
int port←from AggAPI Port
String protocolName←from AggAPI Protocol Name
boolean ssl←from AggAPI SSL Enabled
int interval←from MboxAcctType.interval for given site name
int sizeLimit←from MboxAcctType.sizeLimit for given site name
int timeout=30
String desc←Friendly Name from WC (or null)
boolean rememberPword=true (always true for DA)
boolean alertsEnabled=true (always true for DA)
boolean ignoreold=true
String pwpGuid←from AggAPI PWP Client ID
boolean is DesktopSMC←from AggAPI Is Desktop SMC
boolean is PrimaryUser←from AggAPI Is Primary User
String trackinginfo
String srcMboxId=null
boolean passwdNA←from MailProtocol.protocolSettings&1
String clientType
boolean isValid←from AggAPI Is Valid
boolean suspendedByUser←from AggAPI Suspended By User
boolean suspendedBySystem
boolean disableExpeditedPolling
boolean forceMRUCacheStrategy
String autoBccAddr←from WC (or null)
String signature←from WC (or null)
   The output is: long srcMboxID for newly created SrcMbox row.

ID user names could contain a-z, A-Z, 0-9 plus “.”, “-”, and “_” Also it is a requirement that at least one character must not be a digit (this requirement comes from quickmail). The maximum length is 32.

There is a SMC Mailbox Migration. Some users have WC integrated mailboxes which use the SMC. Currently this would be an older version of the SMC which does not inherently support migration. A newer version of the SMC has been developed which accepts a PROPPATCH command to switch the PWP server that it points to. This makes migration easier, in the sense that the user is not required to intervene (i.e. the user is not required to download or install an SMC) during the migration process.

During user-initiated migration, users with an integrated SMC mailbox(es) will have their SMC changed to use the IS PWP server instead of a WC PWP server. The createMigratedMbox( ) method call takes care of doing this. It uses a SoapServlet property which tells it the WC PWP server host, so it can issue a command using that host and update the SMC to use the new IS PWP server host and update URL values.

Some users will still have an older SMC for various reasons if, for example, they never accepted a “nag” prompt. In this case, the createMigratedMbox call would fail because the PROPPATCH command failed, and the migration would not be completely successful. Since this is considered to occur rarely, the system will inform the user that the migration completed but the SMC mailbox was not migrated. They will have to integrate their SMC mailbox in IS.

There could be UID Migration. In moving from WC to IS, the system has altered the format used to store UIDs (or message IDs) in the database (in the SrcMboxMsg table). In some cases, it is not possible for the migration scripts to derive automatically the new values, so a 100% seamless migration experience is not possible for such sources. In addition, the IS system requires that IMAP sources store a SrcMboxMsg row for each message in the source mailbox (regardless of whether the message was forwarded to the Supervisor), which was not the case in the WC, so there is no choice but to perform a catch-up (“ignoreOld”) poll against the source, in order to build and store the SrcMboxMsg rows.

The rules (by protocol) are as follows:

(1) IMAP (and variants CS2000, AOL), Domino must use catch-up (“ignoreOld”) poll to build and store the SrcMboxMsg rows. This is accomplished by ensuring that “ignoreOld” setting bit is set to TRUE for the source, and that no SrcMboxMsg rows are created for source in BIS-T during migration.

(2) The OWA (Outlook Web Access) is distinguished from OWA 2000 by UID starting with “http.” SrcMboxMsg rows need to be converted during migration.

SrcMboxMsg.uidPart1 MUST match regex:

http.*/forms/ (.+)/formRoot\.asp\?obj=(.+)&command

Assume 2 captures (...) now held in <msgType> and <objId>

In <msgType>, convert all “/” characters to be “-”

characters. davUid=

TeamOnHash(“/inbox/<msgType>#<objId>”).

TeamOnHash(valueIn) returns:

valueIn if length(valueIn)<=24

Digest::MD5::md5_base64(valueIn). “==” otherwise.

(3) ALL OTHER
No conversation required.
davUid=uidPart1

In ALL cases, the SrcMboxMsg.davHref field could be null, since it is only relevant in cases where a notification was sent to a IS Supervisor, which is never the case at the point of migration.

Also, the SrcMboxMsg.msgNumber could be set to some arbitrary (but monotonically increasing) value since it is a mandatory field and must to be unique across all rows having the same srcMboxID. The value for SrcMbox.lastMsgNumber MUST match the MAX(msgNumber) in SrcMboxMsg for the corresponding srcMboxID.

Unlike a mass migration, the user-initiated migration happens without downtime, and within seconds. Retrieving the UIDs would require another call to the System Aggregation database to retrieve the UIDs, which is not part of the existing AggAPI. Therefore, the system could add a new API call to the WC code line, or query the database directly. This could add complexity and risk to the migration process. An alternative is to just do an IgnoreOld poll for all users. An IgnoreOld poll will happen immediately after the SrcMbox row is created resulting in a very small (seconds) window for message loss. The advantages are considerable decrease in migration complexity, allows all protocols to be handled the same, eliminates the chance for duplicate messages, and greatly decreases the migration time resulting in a pleasant user experience. Therefore the decision was made to not migrate the UIDs, but instead force an IgnoreOld poll for all sources.

There are some Service Book Notifications. For each new SRCMbox created in the IS, the system assigns a service book and pushes out a service book notification for it. This could be handled automatically just like any other non-migrating user.

After a users account has been migrated to the IS, the old WC account will remain accessible from the user's handheld for retrieving messages received prior to migration for 30 days. All other UI access and source mailbox polling will be disabled. After 30 days, the account will be deleted from the old WC system.

It is known that there are duplicate external ids in PRV for the same WC username. The migration process will migrate the account actually logged into by the user. This account will reference on externalID in PRV and that externalID will be used to retrieve the aggregation data. If this user happens to have a duplicate account, then the data in the duplicate account will be lost.

XML, of course, as an extensive mark-up language, is a subset of the standard generalized mark-up language (SGML) and would allow data to be stored and published on websites and be richer in presentation. Custom tags could be created to define the content of documents. Common information formats could be created and the format and data shared on the internet, corporate internets and/or other networks. The mark-up symbols in XML could be unlimited and self-defining. The channel definition format (CDF) could describe any channel and a specific CDF file can contain data that specifies an initial web page and how it can be updated.

SOAP allows one program running in one kind of operating system to communicate with the program in the same or another type of operating system by using HTTP and XML for information exchange. SOAP could specify how to encode an HTTP header in an XML file, thus, allowing one computer to call a program in another computer and pass data, while also dictating how it can return a response. SOAP is advantageous to allow data to pass through firewall servers that screen-out requests other than those for known applications to a designated port. SOAP is an XML-based protocol that has at least three parts, including: (a) an envelope to define a framework for describing what is in a message; (b) a set of encoding rules for expressing application-defined data types; and (c) a convention for representing remote procedure calls and responses.

The mobile office platform 16 could include software that is implemented as an ActiveX control as a component object model (COM) and provide a framework for building software components that communicate with each other. ActiveX controls could be automatically downloaded and executed by a web browser. Distributed object applications could be built in active web pages and ActiveX controls could be downloaded to different browsers and clients. ActiveX controls could be held in a web browser as a container and distributed over an internet or corporate intranet. ActiveX controls could also manage and update web content and client systems and work closely with a user interface of a targeted operating system. Java applets or similar component objects could also be used instead of ActiveX controls. It should be understood for purposes of the present invention that an object model control could also be any type of dynamic link library (DLL) module that runs in a container as an application program using a component object model program interface.

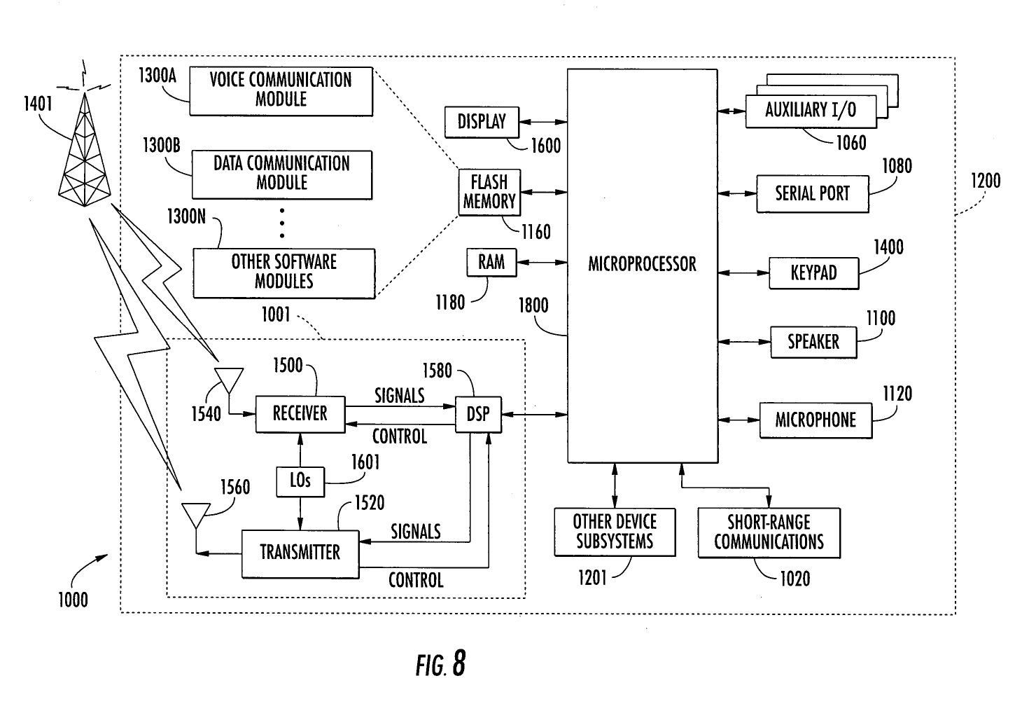

An example of a handheld mobile wireless communications device 1000 that may be used is further described in the example below with reference to FIG. 8. The device 1000 illustratively includes a housing 1200, a keypad 1400 and an output device 1600. The output device shown is a display 1600, which is preferably a full graphic LCD. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400 by the user.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 8. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 is preferably a two-way RF communications device having voice and data communications capabilities. In addition, the mobile device 1000 preferably has the capability to communicate with other computer systems via the Internet.

Operating system software executed by the processing device 1800 is preferably stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM is preferably capable of organizing and managing data items, such as e-mail, calendar events, voice mails, appointments, and task items. The PIM application is also preferably capable of sending and receiving data items via a wireless network 1401. Preferably, the PIM data items are seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, PCS, GSM, etc. Other types of data and voice networks, both separate and integrated, may also be utilized with the mobile device 1000.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore requires a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, or a Bluetooth™ communications module to provide for communication with similarly-enabled systems and devices.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A system for migrating user account data from an integrated electronic mailbox to a new electronic mail service, comprising:
an electronic mail (email) server operative as a web client and having an integrated electronic mailbox of a user and user account data; and
a mobile office platform operative with the email server and having at least one stored procedure call for pulling user account data from the email server into a new electronic mail service at the mobile office platform.

2. A system according to claim 1, wherein said mobile office platform is operative for querying a user of the integrated electronic mailbox whether the user desires to migrate the user account data into the new electronic mail service.

3. A system according to claim 1, wherein said mobile office platform is operative for querying a user to accept new terms and conditions of the new electronic mail service in order to login to a user interface using HTTP or WAP.

4. A system according to claim 1, wherein said email server includes a simple object access protocol (SOAP) interface to pull the user account data of the integrated electronic mailbox.

5. A system according to claim 1, wherein said mobile office platform includes a SOAP interface operative for creating a new, integrated electronic mailbox account for the new electronic mail service.

6. A system for migrating user account data from an integrated electronic mailbox to a new electronic mail service, comprising:
a mobile wireless communications device having a subscriber account associated therewith;
an electronic mail (email) server operative as a web client and having an integrated electronic mailbox for the subscriber account of the user and containing user account data; and
a mobile office platform operative with the email server and having at least one stored procedure call for pulling user account data from the email server into a new electronic mail service at the mobile office platform to be operative with the mobile wireless communications device as a new subscriber account.

7. A system according to claim 6, wherein said mobile office platform is operative for querying a user of the integrated electronic mailbox whether the user desires to migrate the user account data into the new electronic mail service.

8. A system according to claim 6, wherein said mobile office platform is operative for querying a user to accept new terms and conditions of the new electronic mail service in order to login to a user interface using HTTP or WAP at the mobile wireless communications device.

9. A system according to claim 6, wherein said email server includes a simple object access protocol (SOAP) interface to pull the user account data of the integrated electronic mailbox.

10. A system according to claim 6, wherein said mobile office platform includes a SOAP interface operative for creating a new integrated electronic mailbox account.

11. A method of migrating user account data from an integrated electronic mailbox to a new electronic mail service, which comprises:
creating a new integrated electronic mailbox account through the new electronic mail service; and
pulling user account data from the integrated electronic mailbox using at least one procedure call stored within a mobile office platform of the new electronic mail service.

12. A method according to claim 11, which further comprises querying a user of the integrated electronic mailbox whether the user desires to migrate the user account data into the new electronic mail service.

13. A method according to claim 11, which further comprises querying the user to accept new terms and conditions of the new electronic mail service in order to login to a user interface using HTTP or WAP.

14. A method according to claim 11, which further comprises using a simple object access protocol (SOAP) interface to pull the user account data from the integrated electronic mailbox.

15. A method according to claim 14, which further comprises locating the SOAP interface at an email server operative as a web client.

16. A method according to claim 11, which further comprises using a SOAP interface at the mobile office platform to create a new integrated electronic mailbox account.

17. A method according to claim 11, which further comprises creating a hosted mailbox and populating the mailbox with the account data from the integrated electronic mailbox.

18. A method according to claim 11, which further comprises deleting the integrated electronic mailbox after migration.

19. A method according to claim 11, which further comprises delivering service books used at the integrated electronic mailbox before delivering electronic mail to the user using the new electronic mail service.

20. A method according to claim 11, which further comprises communicating from the new electronic mail service with a portable wireless communications device.
